(19) United States
(12) Patent Application Publication
(10) Pub. No.: US 2006/0024991 A1
(43) Pub. Date: Feb. 2, 2006

(54) Connection device with plurality return paths

(75) Inventors: Kevin Kuo, Shindian City (TW); Langhans Chang, Shindian City (TW)

Correspondence Address: BACON & THOMAS, PLLC, 625 SLATERS LANE, FOURTH FLOOR, ALEXANDRIA, VA, 22314, US

(73) Assignee: VIA Technologies, Inc., Shindian City (TW)

(21) Appl. No.: 11/036,116

(22) Filed: Jan. 18, 2005

(30) Foreign Application Priority Data
Jul. 29, 2004 (TW) 093122695

(51) Int. Cl. H01R 12/00

(52) U.S. Cl. 439/74

(57) ABSTRACT

A connection device with plurality return paths includes a first connection component and a second connection component. The first connection component has a rectangular containing portion, a plurality of first pins and two first ground pads. The first pins are disposed at two long sides of the rectangular containing portion. The first ground pads are disposed at two short sides of the rectangular containing portion. The second connection component has a rectangular protruding portion corresponding to the rectangular containing portion, a plurality of second pins and two second ground pads. The second pins are disposed at two long sides of the rectangular protruding portion. The second ground pads are disposed at two short sides of the rectangular protruding portion. When the rectangular protruding portion is inserted into the rectangular containing portion, each first pin connects to each second pin, and each first ground pad connects to each second ground pad.

### BACKGROUND OF THE INVENTION

1. Field of Invention

The invention relates to a connection device and, in particular, to a connection device with a plurality of return paths.

2. Related Art

The connection devices and related products have been developed for a long time. In the initial stage, they were only used for connecting circuitries, and are, for example, electrical plugs, electrical socket, and the likes. Recently, since the computer information industries and network are widely spread, the requirement of the relative devices and electrical components is greatly increased. At the same time, the connection devices have been developed from the traditional types to the digital types, and the functions thereof are enhanced for transmitting sound signals, image signals, information signals and the likes. Moreover, the present connection devices must be capable of high-frequency transmission, which emphasizes the high-speed transmission.

Regarding the connection devices for the computer information industry, a board-to-board connector is mainly employed in the electrical information devices such as the laptop computer, digital camera, mobile phone, PDA, and the likes. The application scope of the board-to-board connector is very wild, and the board-to-board connector is suitable for products of different levels according to the pin pitches thereof. For example, the board-to-board connector with pin pitches of 2.54 mm is usually used in a PC system, the board-to-board connector with pin pitches of 2.00 mm is usually used in the power supply of a laptop computer, and the board-to-board connector with pin pitches between 0.5 to 1.27 mm, which has small dimension and is capable of carrying high current signals, is usually used in the portable products.

With reference to FIG. 1, a conventional board-to-board connector 1 includes a female connection component 11 and a male connection component 13. The female connection component 11 has a rectangular containing portion 111 and a plurality of first pins 113 disposed at two long sides of the rectangular containing portion 111. The male connection component 13 has a rectangular protruding portion 131 and a plurality of second pins 133 disposed at two ling sides of the rectangular protruding portion 131. In general, the rectangular containing portion 111 is corresponding to the rectangular protruding portion 131. When the rectangular protruding portion 131 is inserted into the rectangular containing portion 111, each first pin 113 is electrically connected to each second pin 133. In the prior art, the amount of the pins, such as 40 pins, 60 pins or 80 pins, is depending on the length of the rectangular containing portion 111 or the rectangular protruding portion 131. As shown in FIG. 1, the board-to-board connector 1 has 40 pins.

However, the present electrical products have the trend toward micrified, so that the board of the electrical product is minimized accordingly. Thus, the layout designed for the board has higher density, which results in the problem of space insufficient for installing the board-to-board connector. Therefore, those skilled in the art may decrease the ground pins of the board-to board connector, so as to increase the pins for transmitting signals. As this manner, however, the ground pins may be insufficient, which results in serious electromagnetic interfere (EMI) to affect the normal transmission of signals.

It is therefore an important subjective to provide a connection device, such as a board-to-board connection device, which has extra ground pads for providing more return paths so as to decrease EMI.

### SUMMARY OF THE INVENTION

In view of the foregoing, the invention is to provide a connection device, which has extra ground pads for providing a plurality of return paths.

To achieve the above, a connection device with a plurality of return paths of the invention includes a first connection component and a second connection component. The first connection component has a rectangular containing portion, a plurality of first pins and two first ground pads. The first pins are disposed at two long sides of the rectangular containing portion, and the first ground pads are disposed at two short sides of the rectangular containing portion, respectively. The second connection component has a rectangular protruding portion corresponding to the rectangular containing portion, a plurality of second pins and two second ground pads. The second pins are disposed at two long sides of the rectangular protruding portion, and the second ground pads are disposed at two short sides of the rectangular protruding portion, respectively. When the rectangular protruding portion is inserted into the rectangular containing portion, each first pin electrically connects to each corresponding second pin, and each first ground pad electrically connects to each corresponding second ground pad.

The invention also discloses a connection component with a plurality of return paths, which includes a rectangular containing portion, a plurality of pins and two ground pads. In the invention, the pins are disposed at two long sides of the rectangular containing portion, respectively. The ground pads are disposed at two short sides of the rectangular containing portion, respectively.

In addition, the invention discloses a connection component with a plurality of return paths, which includes a rectangular protruding portion, a plurality of pins and two ground pads. In the invention, the pins are disposed at two long sides of the rectangular protruding portion, respectively. The ground pads are disposed at two short sides of the rectangular protruding portion, respectively.

As mentioned above, the connection device with a plurality of return paths of the invention not only includes the pins as the configuration of prior art, but also has the ground pads disposed at two short sides of the rectangular containing portion or rectangular protruding portion. Therefore, the connection device of the invention can provide extra ground pads for more return paths. As a result, the EMI can be efficiently reduced.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional board-to-board connector;

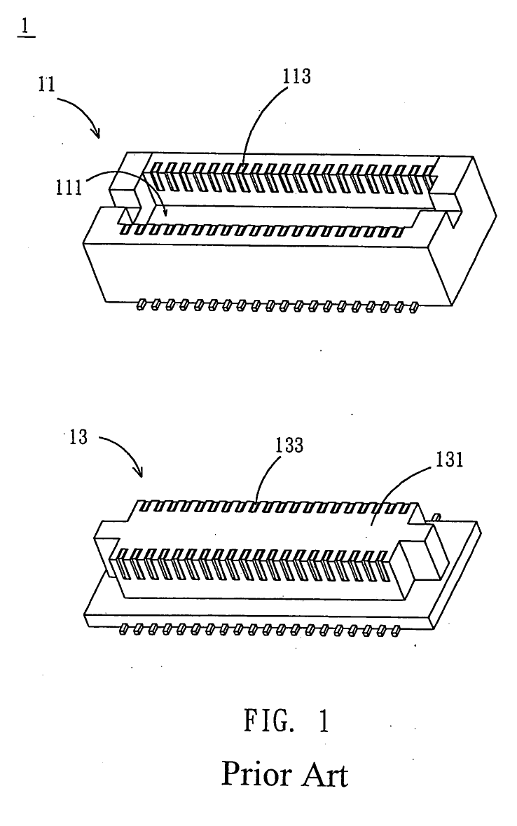

FIG. 2 is a schematic view showing a connection device with a plurality of return paths according to an embodiment of the invention; and

FIG. 3 is a schematic view showing the connection device with a plurality of return paths installed on a board.

### DETAILED DESCRIPTION OF THE INVENTION

The present invention will be apparent from the following detailed description, which proceeds with reference to the accompanying drawings, wherein the same references relate to the same elements. To be noted, although the following embodiment takes a board-to-board connection device as an example, the scope of the invention should not be limited to it.

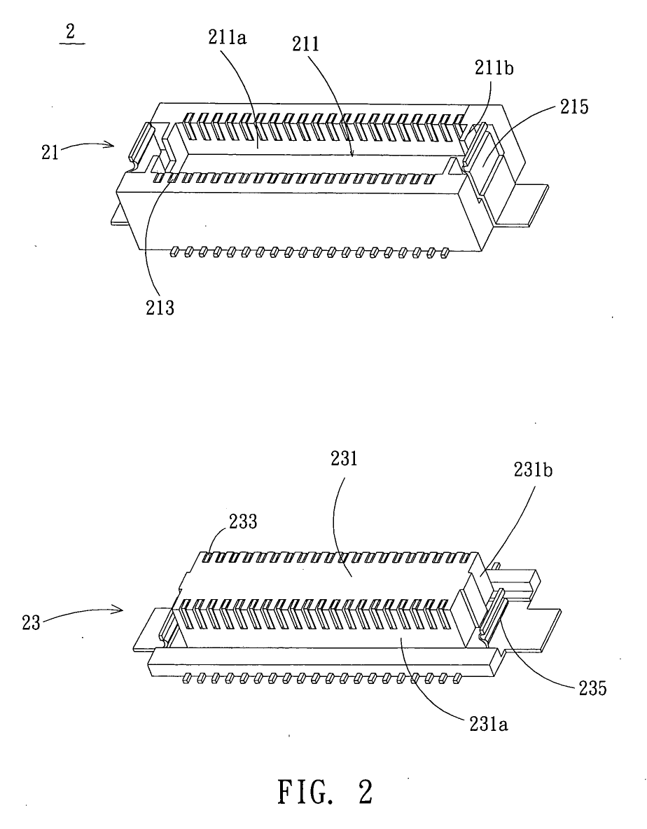

With reference to FIG. 2, a connection device 2 with a plurality of return paths according to a preferred embodiment of the invention includes a first connection component 21 and a second connection component 23.

In this embodiment, the first connection component 21 is a female connection component, and has a rectangular containing portion 211, a plurality of first pins 213, and two first ground pads 215. The first pins 213 are disposed at two long sides 211a of the rectangular containing portion 211. The first ground pads 215 are disposed at two short sides 211b of the rectangular containing portion 211. The second connection component 23 is a male connection component, and has a rectangular protruding portion 231, a plurality of second pins 233, and two second ground pads 235. The second pins 233 are disposed at two ling sides 231a of the rectangular protruding portion 231. The second ground pads 235 are disposed at two short sides 231b of the rectangular protruding portion 231. As shown in FIG. 2, the first connection component 21 has forty first pins 213, and the second connection component 23 has forty second pins 233. In other words, the connection device 2 of the embodiment has 40 pins. To be noted, the amount of the connection device 2 can be determined according to actual demands and may be 60 pins or 80 pins.

As mentioned above, to connecting the first connection component 21 and the second connection component 23, the rectangular protruding portion 231 is inserted into the rectangular containing portion 211. Herein, each first pin 213 touches and electrically connects with one corresponding second pin 233, and each first ground pad 215 touches and electrically connects with one corresponding second ground pad 235.

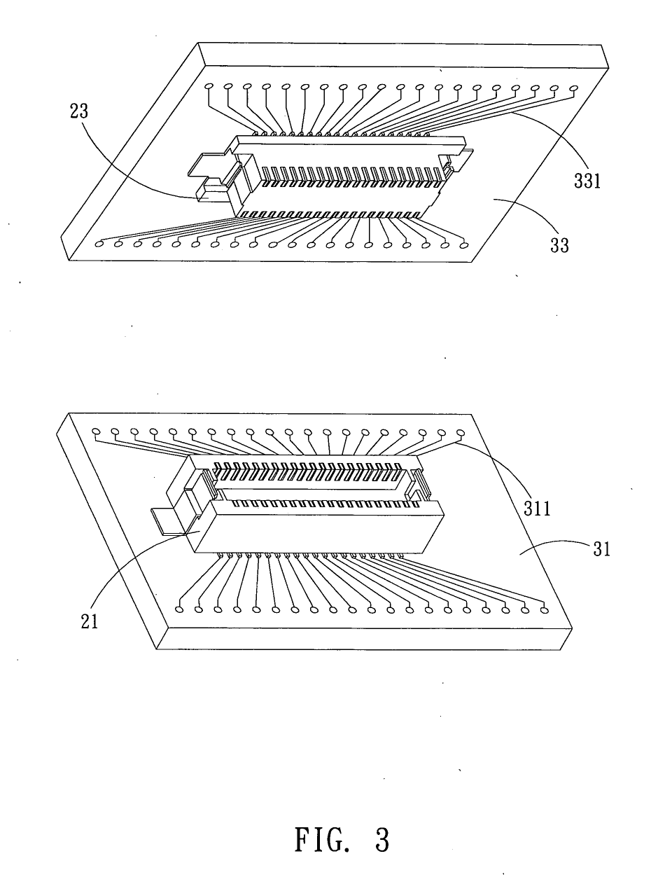

Referring to FIG. 3, regarding to the applications of the connection device 2, the first connection component 21 is usually installed on a first board 31 and the second connection component 23 is usually installed on a second board 33. In the present embodiment, the first connection component 21 and second connection component 23 are respectively installed on the first board 31 and second board 33 by the Surface Mount Technology (SMT). The first board 31 or the second board 33 can be a main board and/or daughter board. As mentioned above, when the first connection component 21 is installed on the first board 31, each of the first pins 213 is electrically connected to one corresponding trace 311 of the first board 31. Similarly, when the second connection component 23 is installed on the second board 33, each of the second pins 233 is electrically connected to one corresponding trace 331 of the second board 33. Moreover, the first ground pads 215 are electrically connected to the first board 31 and are grounded via the first board 31. The second ground pads 235 are electrically connected to the second board 33 and are grounded via the second board 33. When assembling the first connection component 21 and the second connection component 23 to connect the first board 31 and the second board 33, the signal transmissions between the first board 31 and the second board 33 are performed through the corresponding first pins 213 and second pins 233. In addition, the connection device 2 has several extra ground pads, such as the first ground pads 215 and second ground pads 235, which are not shown in the prior art, so that it can provide more return paths to efficiently reduce the EMI of the board(s).

Furthermore, the first ground pads 215 and second ground pads 235 can be welded to the first board 31 and second board 33, respectively. This may build required conductive paths, and may efficiently fix the first connection component 21 and second connection component 23 on the first board 31 and second board 33, respectively. In the current embodiment, the first ground pads 215 and the second ground pads 235 can be both or either compressible elements, so that the first ground pads 215 and second ground pads 235 may buckled to each other properly. As shown in FIGS. 2 and 3, each of the first ground pads 215 and second ground pads 235 has a curved-shape design for the connecting of the corresponding first ground pad 215 and second ground pad 235.

In summary, the connection device with a plurality of return paths of the invention has several ground pads disposed at two short sides of the rectangular containing portion or rectangular protruding portion. According to the invent configuration distinct from the conventional pin design, the connection device of the invention can provide extra ground pads for more return paths and then efficiently reduce the EMI.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A connection device with a plurality of return paths, comprising:
a first connection component, which has a rectangular containing portion, a plurality of first pins and two first ground pads, wherein the first pins are disposed at two long sides of the rectangular containing portion, respectively, and the first ground pads are disposed at two short sides of the rectangular containing portion, respectively; and
a second connection component, which has a rectangular protruding portion corresponding to the rectangular containing portion, a plurality of second pins and two second ground pads, wherein the second pins are disposed at two long sides of the rectangular protruding portion, respectively, the second ground pads are disposed at two short sides of and spaced from the rectangular protruding portion, respectively, and when the rectangular protruding portion is inserted into the rectangular containing portion, each of the first pins electrically connects to each of the second pins and each of the first ground pads electrically connects to each of the second ground pads,
wherein the first ground pads and the second ground pads are compressible elements for buckling with the second ground pads, respectively.

2. The connection device of claim 1, wherein the first connection component is installed on a first board and the second connection component is installed on a second board.

3. The connection device of claim 2, wherein the first pins are electrically connected to the first board, and the second pins are electrically connected to the second board.

4. The connection device of claim 2, wherein the first ground pads are electrically connected to the first board and grounded via the first board, and the second ground pads are electrically connected to the second board and grounded via the second board.

5. (canceled)

6. (canceled)

7. A connection component with a plurality of return paths, comprising:
a rectangular containing portion;
a plurality of pins, which are disposed at two long sides of the rectangular containing portion, respectively; and
two ground pads, which are disposed at two short sides of and spaced from the rectangular containing portion, respectively,
wherein the ground pads are compressible elements.

8. The connection component of claim 7, which is installed on a board.

9. The connection component of claim 8, wherein the pads are electrically connected to the board.

10. The connection component of claim 8, wherein the ground pins are electrically connected to the board and grounded via the board.

11. (canceled)

12. A connection components with a plurality of return paths, comprising:
a rectangular protruding portion;
a plurality of pins, which are disposed at two long sides of the rectangular protruding portion, respectively; and
two ground pads, which are disposed at two short sides of and spaced from the rectangular protruding portion, respectively,
wherein the ground pads are compressible elements.

13. The connection component of claim 12, which is installed on a board.

14. The connection component of claim 13, wherein the pads are electrically connected to the board.

15. The connection component of claim 13, wherein the ground pins are electrically connected to the board and grounded via the board.

16. (canceled)
